(19) United States
(12) Patent Application Publication
(10) Pub. No.: US 2024/0354977 A1
(43) Pub. Date: Oct. 24, 2024

(54) IMAGING SYSTEM AND METHOD OF CORRECTING SUBJECT DEPTH

(71) Applicant: Japan Display Inc., Tokyo (JP)

(72) Inventors: Hirondo NAKATOGAWA, Tokyo (JP); Yoshiro AOKI, Tokyo (JP); Hitoshi TANAKA, Tokyo (JP)

(21) Appl. No.: 18/625,442

(22) Filed: Apr. 3, 2024

(30) Foreign Application Priority Data
Apr. 18, 2023 (JP) 2023-067863

(51) Int. Cl. G06T 7/50

(52) U.S. Cl. CPC G06T 7/50; G06T 2207/30261

(57) ABSTRACT

Provided is an imaging system including an imaging device having an optical system and configured to perform coded imaging of a subject including a reference object separated by a first distance from the optical system, a depth estimation unit configured to decode an image captured by the imaging device to estimate a depth at each position of the subject from the optical system, a temperature identifying unit configured to obtain an ambient temperature of the imaging device based on an estimated depth of the reference object and the first distance, and a correction unit configured to correct the depth of the subject based on the obtained ambient temperature.

### CROSS REFERENCES TO RELATED APPLICATIONS

The present application claims priority to Japanese Patent Application No. 2023-067863 filed on Apr. 18, 2023, the disclosure of which is incorporated herein by reference.

### TECHNICAL FIELD

The present invention relates to an imaging system and a method of correcting a subject depth.

### BACKGROUND

In the field of coded imaging, the technology referred to as DFD (Depth From Defocus) has been known. The DFD is a technology for estimating a distance from an optical system of an imaging device to a subject, that is, a depth or perspective of a subject based on a degree of blur of an edge captured in an image obtained by imaging.

The DFD technology is described in, for example, “Coded Aperture Pairs for Depth from Defocus and Defocus Deblurring” C. Zhou, S. Lin and S. K. Nayar, International Journal of Computer Vision, Vol. 93, No. 1, pp. 53, May 2011 (Non-Patent Document 1). In the DFD technology, the coded imaging in which a subject is imaged using a mask referred to as a coded aperture arranged in a light incident region of an optical system is performed. Next, the captured image obtained by the coded imaging is subjected to decoding process based on a point spread function specific to the mask, whereby the depth of the subject is estimated. Note that the point spread function is generally referred to as PSF (Point Spread Function), and is referred to also as a blur function, blur spread function, point image distribution function, or the like.

### SUMMARY

The DFD technology is still in the process of development, and has a lot of room for improvement in the practicality. Due to the above circumstances, a more practical DFD technology has been desired.

An outline of typical inventions disclosed in this application will be briefly described as follows.

A typical embodiment of the present invention is an imaging system including: an imaging device having an optical system and configured to perform coded imaging of a subject including a reference object separated by a first distance from the optical system; a depth estimation unit configured to decode an image captured by the imaging device to estimate a depth at each position of the subject from the optical system; a temperature identifying unit configured to obtain an ambient temperature of the imaging device based on the estimated depth of the reference object and the first distance; and a correction unit configured to correct the depth of the subject based on the obtained ambient temperature.

Also, another typical embodiment of the present invention is a method of correcting a subject depth including: decoding a captured image obtained by performing coded imaging of a subject by an imaging device, the subject including a reference object separated by a first distance from an optical system of the imaging device, thereby estimating a depth at each position of the subject from the optical system; obtaining an ambient temperature of the imaging device based on the estimated depth of the reference object and the first distance; and correcting the subject depth based on the obtained ambient temperature.

### BRIEF DESCRIPTION OF DRAWINGS

FIG. 1 is a diagram schematically showing an installation example of an imaging system according to the first embodiment;

FIG. 2 is a diagram showing an example of a configuration of the imaging system;

FIG. 3 is a diagram showing an example of a configuration of an arithmetic and control processor;

FIG. 4 is a diagram showing an example of functional blocks of the arithmetic and control processor;

FIG. 5 is a diagram showing an example of a relationship among an actual distance of a reference object, an estimated depth value of the reference object, and an ambient temperature;

FIG. 6 is a diagram showing an example of a relationship among an actual distance of a subject, an estimated subject depth value, and an ambient temperature;

FIG. 7 is a diagram showing an example of a table as depth correction information; and

FIG. 8 is a flowchart showing an example of an operation flow in the imaging system.

### DETAILED DESCRIPTION OF THE INVENTION

Before describing each embodiment of the present invention, the basic content of the DFD technology and the problems found by the inventors of this application will be described.

The state of blur of a subject in a captured image generally depends on a point spread function determined by an optical system of an imaging device, a shape of a light incident region of the optical system, and others. When a mask that partially blocks light is installed in the light incident region of the optical system, the point spread function is determined for each mask. Imaging a subject with an imaging device having the mask installed therein is referred to as coded imaging. When a subject is captured by coded imaging, an image that is blurred based on a point spread function specific to the mask used is obtained as a captured image.

When this captured image, which is a blurred image, is subjected to a decoding process in which deconvolution based on the point spread function specific to the mask used is performed, a decoded image with improved blur and depth information of an object corresponding to each position of the subject included in the decoded image can be obtained.

Meanwhile, the inventors of this application have found that the problem described below arises when the depth at each position of the subject is estimated by performing the decoding process on the captured image obtained by the coded imaging of the subject by the imaging device as described above.

The inventors of this application have discovered that the estimated depth value of the subject changes depending on the ambient temperature of the imaging device through the research and development of the DFD technology. This phenomenon is thought to be because characteristics of the mask, optical system, and imaging element of the imaging device change due to temperature and the change in characteristics is reflected on the captured image.

Due to the above circumstances, the technique capable of stabilizing the estimation accuracy of the depth of the subject with high precision without depending on the ambient temperature of the imaging device has been desired in the DFD technology.

In view of the above circumstances, the inventors of this application have devised the present invention as a result of intensive studies. Embodiments of the present invention will be described below. Note that the embodiments described below are examples for implementing the present invention, and do not limit the technical scope of the present invention. Furthermore, in the following embodiments, components having the same functions are denoted by the same reference characters, and repetitive description thereof will be omitted unless particularly necessary.

### First Embodiment

The imaging system according to the first embodiment of this application will be described. The imaging system according to the first embodiment of this application includes an imaging device having an optical system and configured to perform coded imaging of a subject including a reference object separated by a first distance from the optical system, a depth estimation unit configured to decode an image captured by the imaging device to estimate a depth at each position of the subject from the optical system, a temperature identifying unit configured to obtain an ambient temperature of the imaging device based on the estimated depth of the reference object and the first distance, and a correction unit configured to correct the depth of the subject based on the obtained ambient temperature. Details of the imaging system are as follows.

FIG. 1 is a diagram schematically showing an installation example of an imaging system 1 according to the first embodiment. Note that the z direction in the drawing is a traveling direction of an automobile 100 moving forward.

As shown in FIG. 1, the imaging system 1 is installed in the automobile 100 which is a vehicle. The imaging system 1 is configured to perform the coded imaging of a subject 90 located in a traveling direction of the automobile 100, that is, in front of the automobile 100. A reference object 101 is arranged on the front side of the automobile 100 such that it falls within the angle of view that the imaging system 1 can capture. Therefore, the imaging system 1 performs coded imaging of the subject 90 including the reference object 101. The reference object 101 is used to identify the ambient temperature required to correct the estimated depth value of the subject 90.

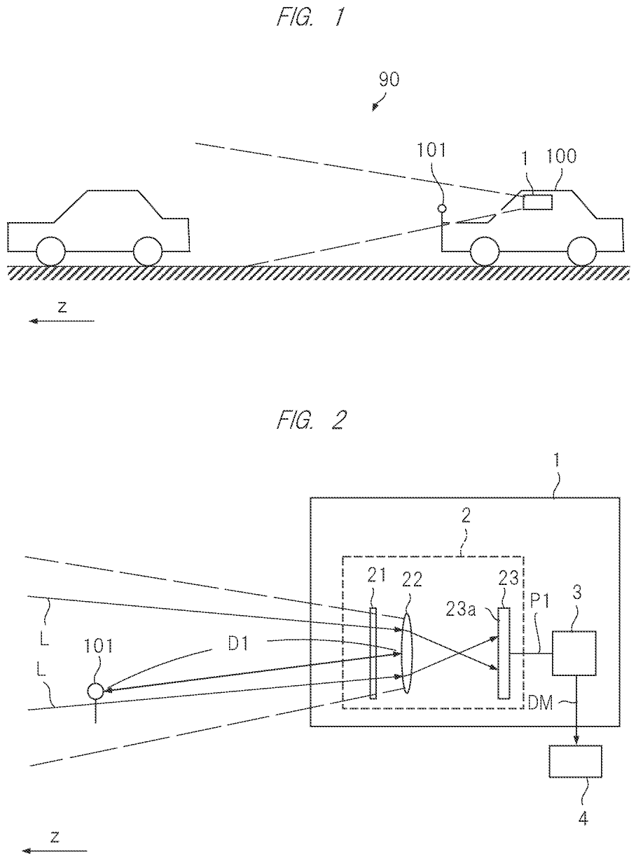

FIG. 2 is a diagram showing an example of a configuration of the imaging system 1. As shown in FIG. 2, the imaging system 1 includes an imaging device 2 and an arithmetic and control processor 3.

The imaging device 2 is installed as a part of the imaging system 1 in the automobile 100 which is a vehicle. The imaging device 2 includes a mask 21, an optical system 22, and an imaging element 23.

The mask 21 has a specific geometric aperture pattern, and functions as a filter for the light that enters the optical system 22 from the subject 90 and reaches the imaging element 23. The mask 21 may be arranged between the optical system 22 and the imaging element 23. Note that the mask 21 is referred to also as a coding aperture.

The optical system 22 forms an image by condensing the light incident from the subject 90 on a light receiving surface 23a of the imaging element 23. The optical system 22 is, for example, a lens. The lens may be a single lens or a compound lens, or may be a single focus lens or a zoom lens.

The imaging element 23 has the light receiving surface 23a, and the light receiving surface 23a is composed of a plurality of photoelectric transducers arranged two-dimensionally. The imaging element 23 converts light L received by the light receiving surface 23a into an electric signal corresponding to the intensity thereof, and outputs image data based on the electric signal to the arithmetic and control processor 3. Note that the imaging element 23 may output the photoelectrically converted electric signal to the arithmetic and control processor 3, and the arithmetic and control processor 3 may obtain the image data based on the electric signal. Note that the imaging element 23 is referred to also as an image sensor.

The imaging device 2 has a point spread function specific to the imaging device 2. The point spread function is a function that determines how a point image on a subject appears blurred in a captured image, and is determined by a combination of the mask 21, the optical system 22, and the imaging element 23.

The reference object 101 is located at a position separated by a first distance D1 from the optical system 22 on the front side of the automobile 100. The positional relationship between the optical system 22 and the reference object 101 is always fixed and maintained during coded imaging. In other words, the first distance D1 (hereinafter, referred to also as the actual distance D1), which is the distance between the optical system 22 and the reference object 101, is known in advance and is basically unchanged except for minute variations caused by vibration or the like of the automobile 100.

The reference object 100 is, for example, a pole provided at a front corner of the automobile 100, an emblem provided at the end of the hood, or the like. Note that the pole, emblem, or the like is already provided on the automobile in some cases. Therefore, when an existing pole or emblem is used as the reference object 101, it is not necessary to additionally provide the reference object for the imaging system 1, and thus possible to reduce the operating cost and monetary cost.

The arithmetic and control processor 3 performs a decoding process on a captured image P1 obtained by the coded imaging. The arithmetic and control processor 3 obtains a decoded image in which the blur of the subject 90 is improved and an estimated depth value at each position of the subject 90 from the optical system by performing the decoding process. The arithmetic and control processor 3 identifies the ambient temperature of the imaging device 2 based on the estimated depth value of the reference object 101 included in the obtained estimated depth value of the subject 90 and the actual distance D1 from the optical system 22 to the reference object 101. Then, the arithmetic and control processor 3 corrects the estimated depth value of the subject 90 based on the identified ambient temperature. The arithmetic and control processor 3 generates a depth map DM by associating the decoded image with the corrected estimated depth value, and outputs the depth map DM to an external device 4 or the like.

FIG. 3 is a diagram showing an example of a configuration of the arithmetic and control processor 3. In this embodiment, the arithmetic and control processor 3 is a computer, and includes a processor 301, a memory 302, an interface 303, and a communication bus 304. The processor 301, the memory 302, and the interface 303 are communicably connected to each other via the communication bus 304. Note that at least a part of the arithmetic and control processor 3 may be constituted by a semiconductor device such as a FPGA (Field Programmable Gate Array), an ASIC (Application Specific Integrated Circuit), or the like.

The processor 301 is, for example, a CPU (Central Processing Unit), a MPU (Micro Processing Unit), a MCU (Micro Controller Unit), a GPU (Graphics Processing Unit), or the like. The processor 301 executes various operations and various processes.

The memory 302 is, for example, a semiconductor memory device, a HDD (Hard Disk Drive), a SSD (Solid State Drive), or the like. The memory 302 stores a program P. When the processor 301 reads and executes the program P stored in the memory 302, the computer functions as various functional blocks.

The interface 303 receives an electric signal or image data representing a captured image from the imaging element 23, and outputs depth information of the subject 90, for example, the depth map DM to the outside.

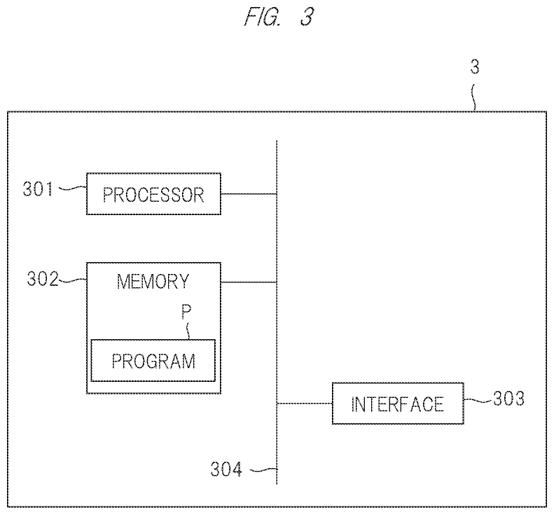

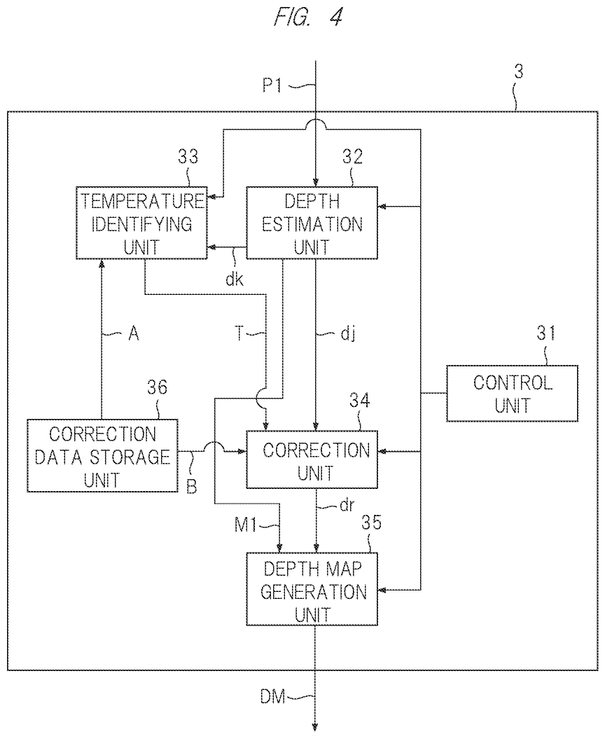

FIG. 4 is a diagram showing an example of functional blocks of the arithmetic and control processor 3. As described above, the functional blocks are realized by the processor 301 executing the program P. As shown in FIG. 4, the arithmetic and control processor 3 includes, as functional blocks, a control unit 31, a depth estimation unit 32, a temperature identifying unit 33, a correction unit 34, a depth map generation unit 35, and a correction data storage unit 36.

The control unit 31 controls each unit so as to receive the captured image P1 by coded imaging, obtain a decoded image M1 and an estimated subject depth value dj by decoding the captured image P1, identify an ambient temperature T, correct the estimated depth value dj, generate the depth map DM, and the like.

The depth estimation unit 32 receives the captured image P1 obtained by coded imaging from the imaging element 23 in accordance with the control from the control unit 31. Further, the depth estimation unit 32 performs the decoding process on the received captured image P1. The decoding process of the captured image P1 is a process by deconvolution based on a point spread function determined by the aperture pattern of the mask 21, the optical system 22, the imaging element 23, and the like. When the decoding process of the captured image P1 is performed, the decoded image M1 that is an image of the subject 90 with improved blur and the estimated depth value dj of the subject 90 from the optical system 22 are obtained. In this specification, the estimated depth value dj represents a set of estimated depth values at each position of the subject 90.

The temperature identifying unit 33 identifies the ambient temperature T of the imaging device 2 based on an estimated depth value dk of the reference object 101 included in the estimated depth value dj of the subject 90 and the actual distance D1 from the optical system 22 to the reference object 101 in accordance with the control from the control unit 31. In this embodiment, the correction data storage unit 36 stores temperature identifying information A which is information representing the correspondence relationship between the estimated depth value dk of the reference object 101 and the ambient temperature T. The temperature identifying 33 unit identifies the ambient temperature T corresponding to the obtained estimated depth value dk of the reference object 101 with reference to the temperature identifying information A stored in the correction data storage unit 36.

Here, a method of identifying the ambient temperature will be described.

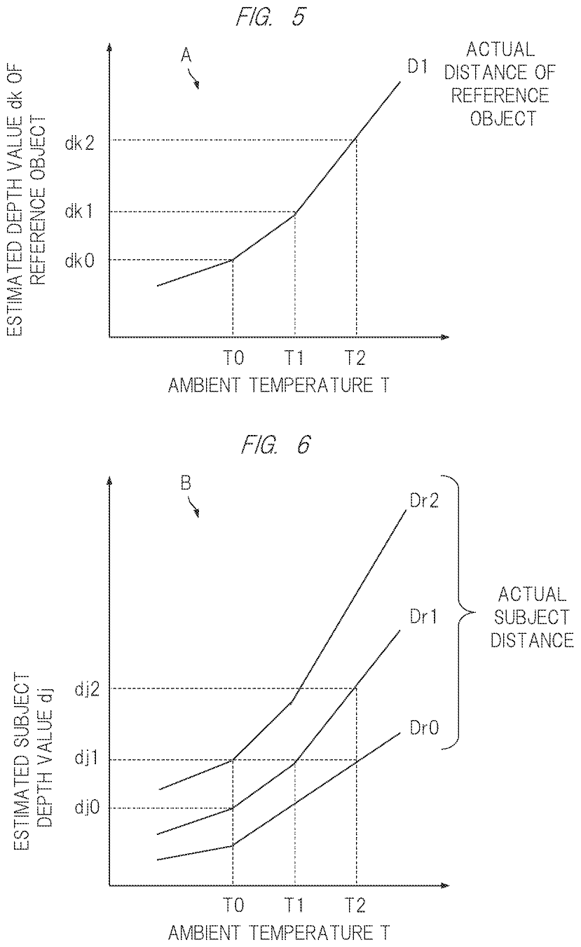

FIG. 5 is a diagram showing an example of a relationship among the actual distance D1 of the reference object, the estimated depth value dk of the reference object, and the ambient temperature T.

As shown in FIG. 5, the estimated depth value dk of the reference object 101 can be expressed by a function g using the actual distance D1 of the reference object 101 and the ambient temperature T as parameters, and can be defined by Equation (1) below.

$$dk = g ( D 1 , T ) \qquad ( 1 )$$

Further, based on Equation (1), the ambient temperature T can be expressed by a function h using the actual distance D1 of the reference object 101 and the estimated depth value dk of the reference object 101 as parameters, and Equation (2) below can be derived.

$$T = h ( D 1 , dk ) \qquad ( 2 )$$

Namely, if the actual distance D1 of the reference object 101 and the estimated depth value dk of the reference object 101 are known, the ambient temperature T can be obtained from the relationship among the actual distance D1, the estimated depth value dk of the reference object, and the ambient temperature T shown in FIG. 5. Since the actual distance D1 of the reference object 101 is known in advance, the ambient temperature T can be uniquely obtained if the estimated depth value dk of the reference object 101 is known.

The relationship among the actual distance D1, the estimated depth value dk of the reference object 101, and the ambient temperature T shown in FIG. 5 can be experimentally determined in advance. The correction data storage unit 36 stores the temperature identifying information A, which is information representing the relationship, as a table or a function.

The temperature identifying unit 33 identifies the ambient temperature T of the imaging device 2 based on the actual distance D1 of the reference object 101 and the estimated depth value dk with reference to the temperature identifying information A stored in the correction data storage unit 36.

The correction unit 34 corrects the estimated depth value dj on the basis of the identified ambient temperature T and the estimated depth value dj for each position of the subject 90 in accordance with the control from the control unit 31, and obtains a corrected estimated depth value dr.

Here, a method of correcting the estimated depth value will be described.

FIG. 6 is a diagram showing an example of a relationship among an actual distance Dr of a subject, the estimated subject depth value dj, and the ambient temperature T.

As shown in FIG. 6, the estimated depth value dj of the subject 90 can be expressed by a function g using the actual distance Dr of the subject 90 and the ambient temperature T as parameters, and can be defined by Equation (3) below.

$$dj = g ( Dr , T ) \qquad ( 3 )$$

Further, based on Equation (3), the actual distance Dr at each position of the subject 90 can be expressed by a function f using the estimated depth value dj and the ambient temperature T as parameters, and Equation (4) below can be derived.

$$Dr = f ( dj , T ) \qquad ( 4 )$$

Namely, if the estimated depth value dj of the subject 90 and the ambient temperature T are known, the actual distance Dr can be obtained from the relationship among the actual distance Dr, the estimated depth value dj, and the ambient temperature T shown in FIG. 6.

The relationship among the actual distance Dr, the estimated depth value dj, and the ambient temperature T shown in FIG. 6 can be experimentally y determined in advance. The correction data storage unit 36 stores depth correction information B, which is information representing the relationship, as a table or a function.

The correction unit 34 identifies the actual distance Dr of the subject 90 for each position of the subject 90 with reference to the depth correction information B stored in the correction data storage unit 36 based on the ambient temperature T and the estimated depth value dj of the subject 90. Then, the correction unit 34 sets the identified actual distance Dr as the corrected estimated depth value dr.

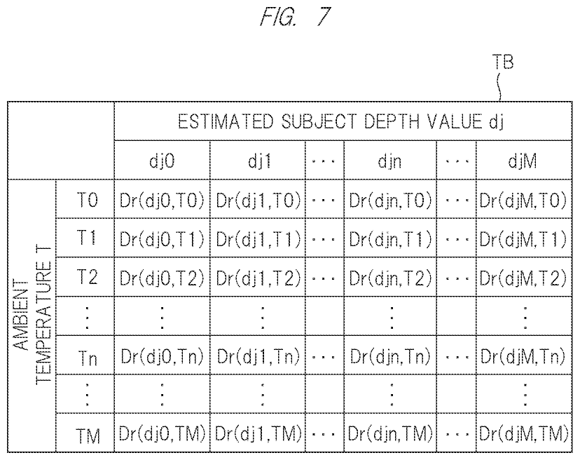

FIG. 7 is a diagram showing an example of a table TB as the depth correction information B. As shown in FIG. 7, in the table TB, for example, dj0, dj1, . . . , djn, . . . , djM are prepared as the values that can be taken as the estimated depth value dj of the subject 90, and T0, T1, T2, . . . , Tn, . . . , TM are prepared as the values that can be taken as the ambient temperature T. Then, the actual distance Dr (djn,Tn) is associated for each arbitrary prepared combination of the estimated depth value djn of the subject 90 and the ambient temperature Tn. The table TB is information representing the relationship between the estimated depth value din before correction and the actual distance Drn to be the corrected estimated depth value drn for the plurality of ambient temperatures Tn. Such table TB may be stored in the correction data storage unit 36 as the depth correction information B.

The depth map generation unit 35 generates the depth map DM in which each position of the subject 90 included in the decoded image M1 is mapped in association with the corrected estimated depth value dr in accordance with the control from the control unit 31. Further, the depth map generation unit 35 outputs the generated depth map DM to the external device 4 or the like.

The correction data storage unit 36 stores the correction data. Examples of the correction data include the temperature A used to identify the ambient identifying information temperature T based on the estimated depth value of the reference object 101 and the depth correction information B used to correct the estimated depth value dj based on the estimated subject depth value and the ambient temperature T. As described above, the temperature identifying information A is the information representing the relationship between the estimated depth value dk of the reference object 101 and the ambient temperature T. Also, the depth correction information B is the information representing the relationship among the actual distance Dr, the estimated depth value dj, and the ambient temperature T.

Note that the relationship among the actual distance Dr, the estimated depth value dj, and the ambient temperature T may be stored in the correction data storage unit 36 for almost all possible combinations of the estimated depth value dj and the ambient temperature T. In this case, however, since the amount of information to be stored is enormous, a large-capacity memory is required, which increases the cost. Therefore, the correction data storage unit 36 may partially store information corresponding to the combinations of the estimated depth value dj and the ambient temperature T, and may compensate combinations, which are not stored, by interpolating the stored information.

Hereinafter, an operation flow in the imaging system 1 will be described.

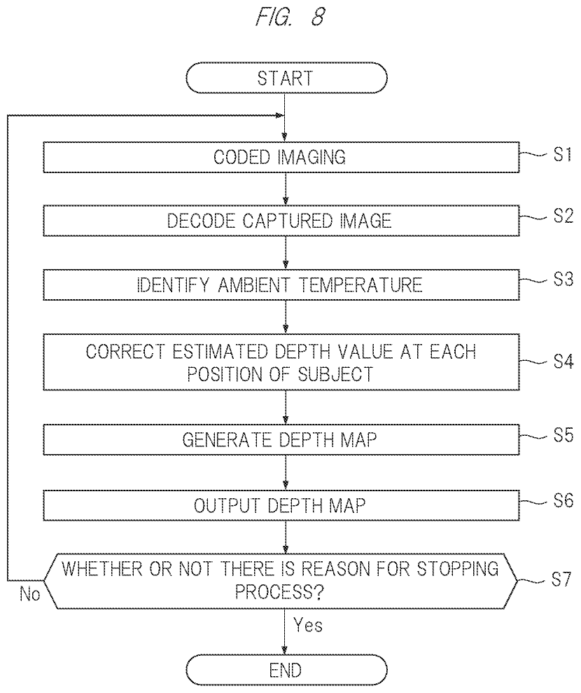

FIG. 8 is a flowchart showing an example of an operation flow in the imaging system 1.

As shown in FIG. 8, in step S1, a process of performing coded imaging is performed. Specifically, the depth estimation unit 32 performs coded imaging of the subject 90 by reading the image data from the imaging element 23 in accordance with the control from the control unit 31, thereby obtaining a captured image.

In step S2, a process of decoding the captured image is performed. Specifically, the depth estimation unit 32 performs the decoding process on the captured image P1 in accordance with the control from the control unit 31, thereby obtaining the decoded image M1 of the subject 90 and the estimated depth value dj at each position of the subject 90. The obtained estimated depth value dj at each position of the subject 90 includes the estimated depth value dk of the reference object 101.

In step S3, a process of identifying the ambient temperature is performed. Specifically, the temperature identifying unit 33 identifies the ambient temperature T of the imaging device 2 based on the actual distance D1 of the reference object 101 and the estimated depth value dk of the reference object 101 with reference to the relationship among the actual distance D1 of the reference object 101, the estimated depth value dk of the reference object 101, and the ambient temperature T, that is, the temperature identifying information A.

In step S4, a process of correcting the estimated subject depth value is performed. Specifically, the correction unit 34 obtains the actual distance Dr of the subject 90 from the optical system 22 with reference to the relationship among the actual distance Dr, the estimated depth value dj, and the ambient temperature T, that is, the depth correction information B in accordance with the control from the control unit 31, and sets the actual distance Dr as the corrected estimated depth value dr. The correction is performed on the estimated depth value at each position of the subject 90.

In step S5, a process of generating a depth map with the corrected estimated depth value is performed. Specifically, the depth map generation unit 35 generates the depth map DM by associating each position of the decoded image M1 obtained by decoding with the corrected estimated depth value dr at each position of the subject 90 in accordance with the control from the control unit 31.

In step S6, the process of outputting the depth map is performed. Specifically, the depth map generation unit 35 outputs the generated depth map DM to the external device 4 or the like in accordance with the control from the control unit 31. The external device 4 is, for example, a driver assistance device of the automobile 100. When the external device 4 is a driver assistance device, it is possible to use the detected information such as the distance to an obstacle or a preceding vehicle in front of the automobile 100 for automatic braking, cruise control, or the like of the automobile 100.

In step S7, a process of determining whether or not there is a reason for stopping the process is performed. Specifically, the control unit 31 determines whether or not there is a reason for stopping the process (hereinafter, referred to also as a process stopping reason). For example, in a case where a command to stop the process is input from the user or the external device 4 or some kind of error has occurred, it is determined that there is a reason for stopping the process. If there is no such command or error, it is determined that there is no reason for stopping the process. When it is determined that there is the process stopping reason (S7: Yes), the control unit 31 ends the process, and when it is determined that there is no process stopping reason (S7: No), the control unit 31 returns the process step to step S1 to continue the process.

According to this embodiment described above, the imaging system 1 first performs the coded imaging of the subject 90 object 101 whose distance from the including the reference optical system 22 of the imaging device 2 is known in advance, and obtains the estimated depth value dj of the subject 90 by decoding the captured image P1. The relationship between the estimated depth value dk of the reference object 101 and the ambient temperature T of the imaging device 2 can be experimentally determined based on the first distance D1 from the optical system 22 to the reference object 101. In the imaging system 1, the ambient temperature T of the imaging device 2 is identified based on the estimated depth value dk of the reference object 101, and the estimated depth value dj of the subject 90 is corrected based on the identified ambient temperature T.

With such a process of the imaging system 1, the properly corrected estimated depth value dr of the subject 90 can be stably obtained with high accuracy even if the ambient temperature T of the imaging device 2 changes, and a more practical DFD technology can be realized.

Note that a method of correcting an estimated subject depth value in accordance with the process flow in the imaging system 1 is also an embodiment of the present invention. Namely, method of correcting a subject depth including: decoding a captured image obtained by performing coded imaging of a subject by an imaging device, the subject including a reference object separated by a first distance from an optical system of the imaging device, thereby estimating a depth at each position of the subject t from the optical system; obtaining an ambient temperature of the imaging device based on the estimated depth of the reference object and the first distance; and correcting the subject depth based on the obtained ambient temperature is an embodiment of the present invention.

Further, a program for causing a computer to function as the depth estimation unit 32, the temperature identifying unit 33, and the correction unit 34, and a tangible computer-readable storage medium for non-transitorily storing the program are also embodiments of the present invention.

In the foregoing, various embodiments of the present invention have been described, but the present invention is not limited to the above-described embodiments, and includes various modifications. Also, the above embodiments have been described in detail such that the present invention can be easily understood, and the present invention is not necessarily limited to that including all the configurations described above. Also, a part of the configuration of one embodiment may be replaced with the configuration of another embodiment, and the configuration of one embodiment may be added to the configuration of another embodiment. All of these are within the scope of the present invention. Furthermore, numerical values and the like included in the text and the drawings are merely examples, and the effects of the present invention are not impaired even if different values are used.

For example, in the above-described embodiments, the imaging system 1 is installed in an automobile, but the imaging system 1 may be installed in a vehicle other than an automobile, for example, a train of a railway or a monorail, a motorcycle, a bicycle, or the like. The imaging system 1 also has the same effects as those of the above-described embodiments in such installation examples, and can be used in, for example, the driver assistance technology.

What is claimed is:

1. An imaging system comprising:
an imaging device having an optical system and configured to perform coded imaging of a subject including a reference object separated by a first distance from the optical system;
a depth estimation unit configured to decode an image captured by the imaging device to estimate a depth at each position of the subject from the optical system;
a temperature identifying unit configured to obtain an ambient temperature of the imaging device based on the estimated depth of the reference object and the first distance; and
a correction unit configured to correct the depth of the subject based on the obtained ambient temperature.

2. The imaging system according to claim 1, further comprising
a storage unit configured to store information representing a relationship between a depth before correction and a depth after correction for a plurality of ambient temperatures,
wherein the correction unit corrects the depth of the subject based on the information.

3. The imaging system according to claim 1,
wherein the imaging device and the reference object are installed in a vehicle.

4. The imaging system according to claim 3,
wherein the vehicle is an automobile.

5. The imaging system according to claim 4,
wherein the reference object is a pole or an emblem.

6. A method of correcting a subject depth comprising:
decoding a captured image obtained by performing coded imaging of a subject by an imaging device, the subject including a reference object separated by a first distance from an optical system of the imaging device, thereby estimating a depth at each position of the subject from the optical system;
obtaining an ambient temperature of the imaging device based on the estimated depth of the reference object and the first distance; and
correcting the subject depth based on the obtained ambient temperature.

7. The method of correcting the subject depth according to claim 6,
wherein the subject depth is corrected based on information representing a relationship between a depth before correction and a depth after correction for a plurality of ambient temperatures.

8. The method of correcting the subject depth according to claim 6,
wherein the imaging device and the reference object are installed in a vehicle.

9. The method of correcting the subject depth according to claim 8,
wherein the vehicle is an automobile.

10. The method of correcting the subject depth according to claim 9,
wherein the reference object is a pole or an emblem.
